(19) United States
(12) Patent Application Publication
(10) Pub. No.: US 2008/0252232 A1
(43) Pub. Date: Oct. 16, 2008

(54) Magnetic Ballast Fault Isolation System and Method

(75) Inventor: Anand Upadhyay, Lake Forest, IL (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/088,195

(22) PCT Filed: Sep. 19, 2006
(86) PCT No.: PCT/IB06/53373

§ 371 Date: Mar. 26, 2008

(30) Foreign Application Priority Data
Sep. 26, 2005 (US) 60720584
Sep. 19, 2006 (IB) PCT/IB2006/053373

(51) Int. Cl. H05B 37/00

(52) U.S. Cl. 315/289

(57) ABSTRACT

A magnetic ballast fault isolation system and method, with a fault isolation system including a magnetic ballast 22 having a current input 24, the magnetic ballast 22 having an operational current rating and an inrush current rating; and a fast acting fuse 26 operably connected in series with the current input 24, the fast acting fuse 26 having a continuous current rating and an overload current rating. The amperage of the fast acting fuse 26 is selected for the larger of the continuous current rating for a predetermined current factor times the operational current rating and the overload current rating for the inrush current rating.

This invention relates generally to magnetic ballasts, and more specifically to a system and method for isolating magnetic ballast faults.

Magnetic ballasts are used in electrical lighting fixtures, such as high intensity discharge (HID) and fluorescent lighting fixtures, to provide power to the HID or fluorescent lamps. From time-to-time, magnetic ballasts are subject to internal or external faults. Presently, slow acting fuses (slow blow fuses) and/or thermal protectors are installed in series with the input line to the magnetic ballasts to isolate the magnetic ballast in case of a fault. A slow acting fuse is presently used to allow for the high inrush starting current: the slow acting fuse doesn't open when the magnetic ballast is turned on so that normal operation can take place. The thermal protector is physically located in or on the windings of the magnetic ballast and opens to cut the input current to the magnetic ballast when a high temperature is detected at the thermal protector. The thermal protector resets closed when the high temperature clears.

The use of the slow acting fuse and thermal protector, alone or in combination, fails to protect against the full range of faults. The slow acting fuse can take a substantial time, on the order of minutes or hours, to clear a fault just above the fuse rating. If the fault current rises very rapidly, such as can occur in the case of the winding-to-core ground fault, the ballast may fail catastrophically before a slow acting fuse can clear the fault. If the same fault causes a magnetic ballast temperature increase, the thermal protector can open to relieve the fault and reset when the temperature returns to normal, but this causes additional problems. When the fault is permanent, the thermal protector will cycle repeatedly without the fuse permanently clearing the fault. By nature, the temperature setpoint for a thermal protector increases with repeated cycling, so an ever higher magnetic ballast temperature is required before the thermal protector opens. The thermal protector will finally fail closed and no protection will be available to clear the fault.

It would be desirable to provide a magnetic ballast fault isolation system and method that overcomes the above disadvantages.

One aspect of the invention provides a magnetic ballast fault isolation system including a magnetic ballast having a current input, the magnetic ballast having an operational current rating and an inrush current rating; and a fast acting fuse operably connected in series with the current input, the fast acting fuse having a continuous current rating and an overload current rating. The amperage of the fast acting fuse is selected for the larger of the continuous current rating for a predetermined current factor times the operational current rating and the overload current rating for the inrush current rating.

Another aspect of the invention provides a magnetic ballast fault isolation system manufacturing method including providing a magnetic ballast having a current input, the magnetic ballast having an operational current rating and an inrush current rating; determining a continuous current rating for a predetermined current factor times the operational current rating; determining an overload current rating for the inrush current rating; selecting a fast acting fuse having amperage of the larger of the continuous current rating and the overload current rating; and operably connecting the fast acting fuse in series with the current input.

Another aspect of the invention provides a magnetic ballast fault isolation system including magnetic means for providing lamp current from a power supply, the magnetic current providing means receiving operational current and inrush current; and fast acting means for electrically isolating the magnetic current providing means when supplied current exceeds an amperage rating, the fast acting isolating means having a continuous current rating and an overload current rating. The amperage rating is the larger of the continuous current rating for a predetermined current factor times the operational current and the overload current rating for the inrush current.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

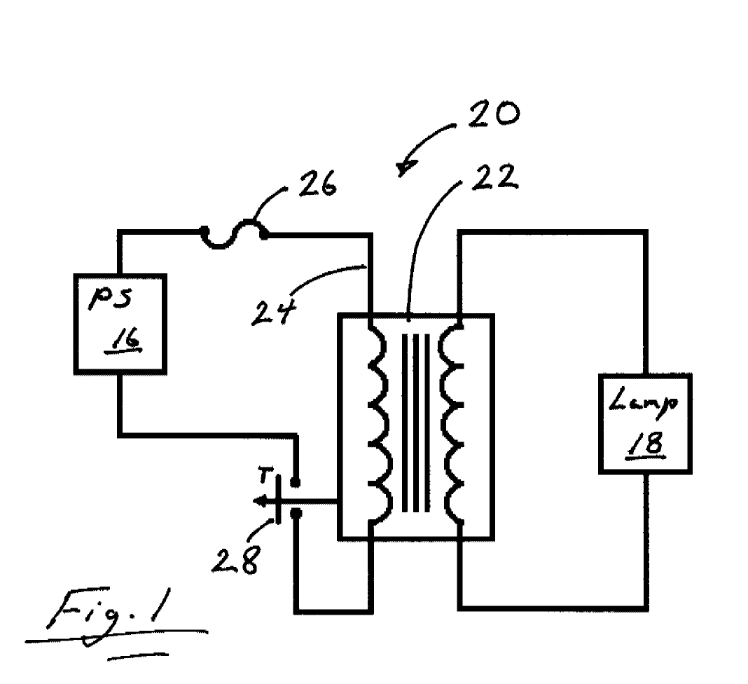

FIG. 1 is a schematic diagram of a magnetic ballast fault isolation system made in accordance with the present invention;

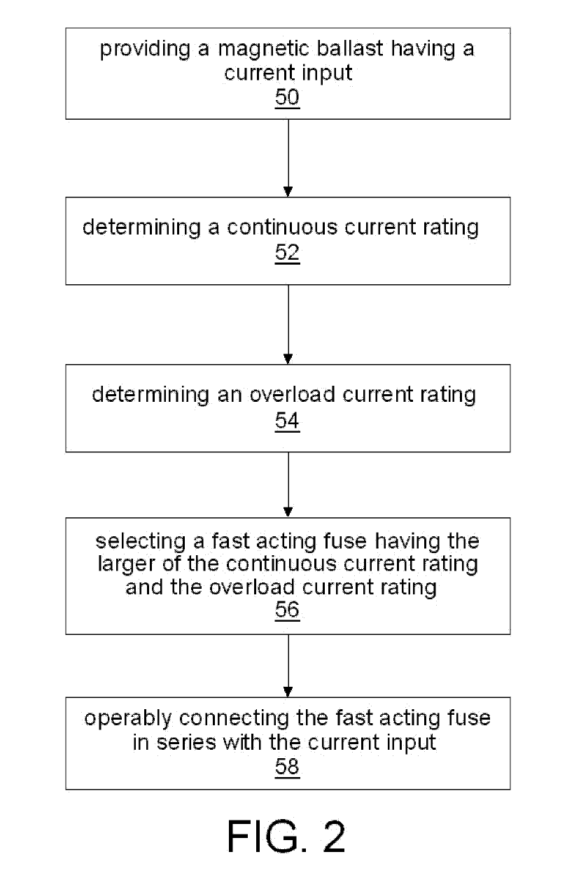

FIG. 2 is a flow chart of a method for manufacturing a magnetic ballast fault isolation system made in accordance with the present invention; and

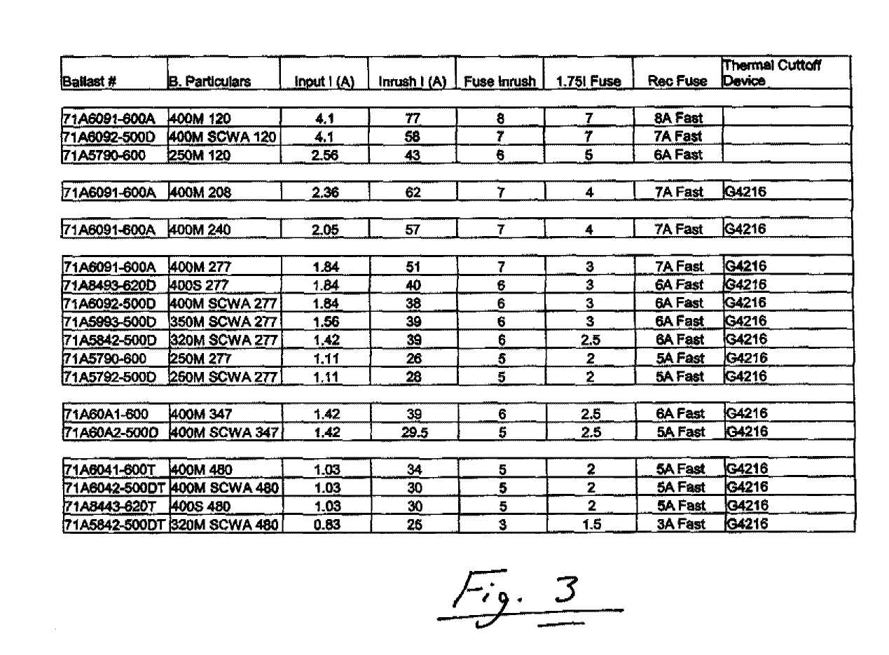

FIG. 3 is a table of various embodiments of a magnetic ballast fault isolation system made in accordance with the present invention.

FIG. 1 is a schematic diagram of a magnetic ballast fault isolation system made in accordance with the present invention. The magnetic ballast fault isolation system 20 includes a magnetic ballast 22 having a current input 24 and a fast acting fuse 26 operably connected in series with the current input 24. The magnetic ballast 22 takes power from power supply 16 to provide current to a lamp 18, such as an HID or fluorescent lamp. The magnetic ballast 22 has an operational current rating for operational current received and an inrush current rating for inrush current received. Those skilled in the art will appreciate that the magnetic ballast 22 is shown as a simple transformer for clarity of illustration and that the magnetic ballast 22 can be a simple transformer, an inductor, an auto-transformer, a transformer with additional circuits or systems such as power factor correction circuits and/or igniter systems, or any other magnetic ballast as desired for a particular application. The fast acting fuse 26 has a continuous current rating and an overload current rating. The amperage for the fast acting fuse 26 is selected for the larger of the continuous current rating for a predetermined current factor times the operational current rating and the overload current rating for the inrush current rating. The predetermined current factor is typically between about 1.5 and 2.5, and can be about 1.75. In one embodiment, the magnetic ballast fault isolation system 20 includes an optional thermal protection device 28, such as a thermal protector or a thermal cutoff, operably connected in series with the current input 24. The thermal protection device 28 is thermally connected to the magnetic ballast 22 to sense the temperature of the magnetic ballast 22 and open at a predetermined temperature, such as 135 degrees Celsius, to cut off current to the magnetic ballast 22. The thermal protection device 28 can be physically located externally to the magnetic ballast 22 on the outside or internally within the inside of the magnetic ballast 22, such as within the windings.

The fast acting fuse 26 can be any fast acting fuse suitable for the operating parameters of the magnetic ballast 22. The fast acting fuse 26 electrically isolates the magnetic ballast 22 when the supplied current exceeds an amperage rating for a given time. Fast acting fuses lack slow-blowing features and open very quickly on overload and short-circuit conditions. Fast acting fuses can clear a fault in a much shorter time than a slow blow fuse. In accordance with Underwriters Laboratories (UL) standards, fast acting fuses are required to clear a fault by a maximum time, while slow blow fuses are required to clear a fault within a time range. For the example of a 200 percent overload fault, a fast acting fuse will clear the fault in less than 5 seconds, while a slow blow fuse will clear the fault in 5 to 30 seconds.

The amperage of the fast acting fuse 26 is selected for the larger of the continuous current rating for a predetermined current factor times the operational current rating and the overload current rating for the inrush current rating. The continuous current rating for a predetermined current factor times the operational current rating and the overload current rating for the inrush current rating are typically about equal for low voltage magnetic ballasts, such as low voltage magnetic HID ballasts. As defined herein, “selected for the larger” includes selection of either value when the continuous current rating for a predetermined current factor times the operational current rating and the overload current rating for the inrush current rating are equal or approximately equal. Exemplary 3AB, 3AG, 2AB, and 2AG series fast acting fuses are available from Littelfuse, Inc., of Des Plaines, Ill. Other exemplary GDA series fast acting fuses are available from Cooper/Bussman, of St. Louis, Mo.

The optional thermal protection device 28 can be any thermal protection device suitable for the operating parameters of the magnetic ballast 22. The thermal protection device 28 opens when the sensed portion of the magnetic ballast 22 reaches a predetermined temperature. The predetermined temperature can be determined from the normal operating temperature and the operating environment of the magnetic ballast 22. In one embodiment, the predetermined temperature is 135 degrees Celsius. In one embodiment, the thermal protection device 28 is a thermal protector that opens when the sensed portion of the magnetic ballast 22 reaches a predetermined temperature and closes to reset when the magnetic ballast 22 cools below the predetermined temperature. The exemplary 7AM family of thermal protectors is available from Texas Instruments of Attleboro, Mass. In another embodiment, the thermal protection device 28 is a thermal cutoff that opens when the sensed portion of the magnetic ballast 22 reaches a predetermined temperature and remains open. Exemplary G4216 Microtemp® thermal cutoffs are available from Therm-O-Disc of Mansfield, Ohio, a subsidiary of Emerson. Other exemplary thermal cutoffs are the D series of thermal cutoffs available from Honeywell of Morristown, N.J.

FIG. 2 is a flow chart of a method for manufacturing a magnetic ballast fault isolation system made in accordance with the present invention. The method includes providing a magnetic ballast having a current input, the magnetic ballast having an operational current rating and an inrush current rating 50; determining a continuous current rating for a predetermined current factor times the operational current rating 52; determining an overload current rating for the inrush current rating 54; selecting a fast acting fuse having the larger of the continuous current rating and the overload current rating 56; and operably connecting the fast acting fuse in series with the current input 58. When the continuous current rating and the overload current rating differ by more than a predetermined difference, the method can also include operably connecting a thermal protection device, such as a thermal protector or a thermal cutoff, in series with the current input.

FIG. 3 is a table of various embodiments of a magnetic ballast fault isolation system made in accordance with the present invention. The table illustrates the parameters used to select the amperage rating of the fast acting fuse and to decide when a thermal protection device is desirable.

The first column of FIG. 3 (Ballast #) lists the model number of exemplary magnetic ballasts available from Advance Transformer Company of Rosemont, Ill., a division of Philips Electronics North America. The second column of FIG. 3 (B. Particulars) lists particulars for the ballast model of the first column. Particulars include the wattage, such as 400, 250; lamp type, such as M (Metal Halide), S (High Pressure Sodium); circuit type, such as SCWA (Super Constant Wattage Autotransformer); and operating voltage, such as 120, 208, 240. The third and fourth columns of FIG. 3 list the operational current rating (Input I) and inrush current rating (Inrush I), respectively, for the ballast model of the first column. The operational current rating is the steady state operating current in Amps for the magnetic ballast, while the inrush current rating is the maximum starting current in Amps. The fifth column of FIG. 3 (Fuse Inrush) lists the overload current rating, i.e., the current allowed to pass, for a fast acting fuse corresponding to the inrush current rating of the ballast model of the first column. The sixth column of FIG. 3 (1.75I Fuse) lists the continuous current rating corresponding to the predetermined current factor times the operational current rating of the ballast model of the first column. In these examples, the predetermined current factor is 1.75. The seventh column of FIG. 3 (Rec Fuse) lists the recommended amperage for the fast acting fuse based on the larger of the continuous current rating for a predetermined current factor times the operational current rating and the overload current rating for the inrush current rating. The eighth column of FIG. 3 (Thermal Cutoff Device) lists the recommended thermal protection device when the predetermined current factor times the operational current rating and the overload current rating differ by more than a predetermined difference. In these examples, the recommended thermal protection device is a G4216 Microtemp® thermal cutoff available from the Therm-O-Disc of Mansfield, Ohio, a subsidiary of Emerson. In other embodiments, the thermal protection device is a thermal protector. The rows of the eighth column are blank when no thermal protection device is required. Even when no thermal protection device is required, an optional thermal protection device can be used to increase overall isolation effectiveness.

In determining the parameters for the magnetic ballast fault isolation system, the operational current rating and inrush current rating can be determined from the manufacturer's specifications for the selected magnetic ballast or experimentally. The overload current rating is determined by reviewing the manufacturer's specifications for fast acting fuses and identifying a fast acting fuse which can withstand the inrush current rating for the selected magnetic ballast. The overload current rating is the steady state current rating for the identified fast acting fuse. The continuous current rating is determined by multiplying a predetermined current factor times the operational current rating for the selected magnetic ballast. The predetermined current factor is typically between about 1.5 and 2.5 and, in this example is 1.75. The predetermined current factor accounts for variability in the overload current rating due to factors such as unit-to-unit variation in the ballast output rating, ballast input current variation from a lamp-to-lamp variation, increased current draw over lamp life (particularly at the end of lamp life), potential for high ballast operating temperature from high ambient temperature, and the like. The recommended amperage for the fast acting fuse is based on the larger of the continuous current rating and the overload current rating. As defined herein, “the larger” includes either value when the continuous current rating and the overload current rating are equal or approximately equal. When the continuous current rating and the overload current rating differ by less than a predetermined difference, no thermal protection device is required, although an optional thermal protection device can be used as desired for additional protection. When the continuous current rating and the overload current rating differ by more than a predetermined difference, a thermal protection device can be used. In one embodiment, the predetermined difference is about 2 to 3 Amps. In another embodiment, the predetermined difference is about 50 percent of the overload current rating.

Using the 71A6091-600A magnetic ballast at 120 Volts in the first row of FIG. 3 as one example, the 71A6091-600A magnetic ballast has an operational current rating of 4.1 Amps and inrush current rating of 77 Amps, as indicated by the manufacturer's data. The overload current rating for a fast acting fuse required to handle the inrush current rating of 77 Amps has a steady state operating current of 8 Amps, as indicated by the fast acting fuse manufacturer's data. The continuous current rating corresponding to the predetermined current factor of 1.75 times the operational current rating of 4.1 Amps is 7 Amps. The recommended amperage for the fast acting fuse based on the larger of the continuous current rating of 7 Amps and the overload current rating of 8 Amps is 8 Amps. The continuous current rating of 7 Amps and the overload current rating of 8 Amps differ by less than a predetermined difference, so no thermal protection device is required. A fast acting fuse alone is typically sufficient isolation protection for low voltage magnetic ballasts, such as 120 Volt magnetic ballasts, with an input voltage of less than 200 Volts. In another example of the 71A6092-500D magnetic ballast at 120 Volts in the second row of FIG. 3, the continuous current rating of 7 Amps and the overload current rating of 7 Amps are equal, so that either can be used as the larger value in determining the recommended amperage for the fast acting fuse of 7 Amps.

Using the 71A6091-600A magnetic ballast at 208 Volts in the fourth row of FIG. 3 as another example, the 71A6091-600A magnetic ballast has an operational current rating of 2.36 Amps and inrush current rating of 62 Amps, as indicated by the manufacturer's data. The overload current rating for a fast acting fuse required to handle the inrush current rating of 62 Amps has a steady state operating current of 7 Amps, as indicated by the fast acting fuse manufacturer's data. The continuous current rating corresponding to the predetermined current factor of 1.75 times the operational current rating of 2.36 Amps is 4 Amps. The recommended amperage for the fast acting fuse based on the larger of the continuous current rating of 4 Amps and the overload current rating of 7 Amps is 7 Amps. The continuous current rating of 4 Amps and the overload current rating of 7 Amps differ by more than a predetermined difference of about 2 to 3 Amps, so a thermal protection device is desirable. In this example, a G4216 Microtemp® thermal cutoff available from the Therm-O-Disc of Mansfield, Ohio, a subsidiary of Emerson, is used. A thermal protection device with a fast acting fuse is typically is desirable for isolation protection for higher voltage magnetic ballasts with an input voltage above 200 Volts in which the overload current rating of the fast acting fuse dominates fuse selection. Without thermal protection, a winding fault with a low fault current can exist for an extended time until the winding fault becomes a ground fault and the fast acting fuse opens. In another example of the 71A6091-600A magnetic ballast at 277 Volts in the fifth row of FIG. 3, the continuous current rating of 3 Amps and the overload current rating of 7 Amps differ by more than a predetermined difference of about 50 percent of the overload current rating, so a thermal protection device is desirable.

While the embodiments of the invention disclosed herein are presently considered to be preferred, various changes and modifications can be made without departing from the scope of the invention. The scope of the invention is indicated in the appended claims, and all changes that come within the meaning and range of equivalents are intended to be embraced therein.

1. A fault isolation system comprising:
a magnetic ballast having a current input, the magnetic ballast having an operational current rating and an inrush current rating; and
a fast acting fuse operably connected in series with the current input, the fast acting fuse having a continuous current rating and an overload current rating;
wherein amperage for the fast acting fuse is selected for the larger of the continuous current rating for a predetermined current factor times the operational current rating and the overload current rating for the inrush current rating.

2. The system of claim 1 wherein the predetermined current factor is between about 1.5 and 2.5.

3. The system of claim 1 wherein the current input provides less than 200 Volts to the magnetic ballast.

4. The system of claim 1 further comprising a thermal protection device 28 operably connected in series with the current input.

5. The system of claim 4 wherein the thermal protection device is a thermal protector.

6. The system of claim 4 wherein the thermal protection device is a thermal cutoff.

7. The system of claim 4 wherein the current input 24 provides more than 200 Volts to the magnetic ballast.

8. A magnetic ballast fault isolation system manufacturing method comprising:
providing a magnetic ballast having a current input, the magnetic ballast having an operational current rating and an inrush current rating;
determining a continuous current rating for a predetermined current factor times the operational current rating;
determining an overload current rating for the inrush current rating;
selecting a fast acting fuse having amperage of the larger of the continuous current rating and the overload current rating; and
operably connecting the fast acting fuse in series with the current input 58.

9. The method of claim 8 wherein the predetermined current factor is between about 1.5 and 2.5.

10. The method of claim 8 further comprising operably connecting a thermal protection device in series with the current input when the continuous current rating and the overload current rating differ by more than a predetermined difference.

11. The method of claim 10 wherein the thermal protection device is a thermal protector.

12. The method of claim 10 wherein the thermal protection device is a thermal cutoff.

13. The method of claim 10 wherein the predetermined difference is about 2 to 3 Amps.

14. The method of claim 10 wherein the predetermined difference is about 50 percent of the overload current rating.

15. A fault isolation system comprising:
magnetic means for providing lamp current from a power supply, the magnetic current providing means receiving operational current and inrush current; and
fast acting means for electrically isolating the magnetic current providing means when the supplied current exceeds an amperage rating, the fast acting isolating means having a continuous current rating and an overload current rating;
wherein the amperage rating is the larger of the continuous current rating for a predetermined current factor times the operational current and the overload current rating for the inrush current.

16. The system of claim 15 wherein the predetermined current factor is between about 1.5 and 2.5.

17. The system of claim 15 further comprising thermal means for electrically isolating the magnetic current providing means when temperature of the magnetic current providing means exceeds a predetermined temperature.

18. The system of claim 17 wherein the thermal isolating means is a thermal protector.

19. The system of claim 17 wherein the thermal isolating means is a thermal cutoff.

20. The system of claim 15 wherein the magnetic current providing means has an input voltage greater than 200 Volts.
